(19) United States
(12) Patent Application Publication
(10) Pub. No.: US 2019/0070682 A1
(43) Pub. Date: Mar. 7, 2019

(54) DEVICE FOR MACHINING A WORK-PIECE WITH A TOOL

(71) Applicant: Liebherr-Verzahntechnik GmbH, Kempten (DE)

(72) Inventor: Martin SCHWARZMANN, Kempten (DE)

(21) Appl. No.: 16/123,795

(22) Filed: Sep. 6, 2018

(30) Foreign Application Priority Data
Sep. 7, 2017 (DE) 10 2017 120 570.5
Aug. 31, 2018 (EP) 18192038.0

(51) Int. Cl. B23F 5/02; B23F 17/00; B23Q 39/02; B23F 19/12; B23F 23/00

(52) U.S. Cl. CPC B23F 5/02; B23F 17/006; B23Q 1/4866; B23F 19/12; B23F 23/006; B23Q 39/027

(57) ABSTRACT

The present disclosure relates to a device for machining a work-piece with a tool, including a tool receptacle for releasably clamping a tool, such as a hob peeling wheel, and a machining head, which is provided with the tool receptacle, and is designed to drive a tool clamped therein, and to move it relative to a work-piece to be machined, including an assessment unit for imaging and/or measuring a tool, or a part thereof, in order to detect the state of wear of the tool.

### CROSS REFERENCE TO RELATED APPLICATION

This application claims priority to German Patent Application No. 10 2017 120 570.5, entitled “Device for Machining a Work-Piece with a Tool,” filed Sep. 7, 2017, and European Patent Application No. 18192038.0 filed on Aug. 31, 2018, the entire contents of each are hereby incorporated by reference in their entirety for all purposes.

### TECHNICAL FIELD

The present disclosure relates to a device for machining a work-piece with a tool including a machine tool for gear-cutting machining.

### BACKGROUND AND SUMMARY

With such a machine tool, it is possible to machine a work-piece in an effective manner and to generate a gearing on a work-piece. Here, the machining is carried out with the help of a cutting method.

In each metal cutting, as also in the gear-cutting processing, signs of wear arise due to the high thermal and mechanical stresses of the tool, which entail the wear and tear of the tool, or of its cutting edges. Influencing factors on the form and size of the wearing are here the condition of the tool, the material to be cut itself, as well as the corresponding process parameters. Here, the quality of the work-piece machined with the tool may decrease if the tool is not taken out of the process before the tool wear has too great influence on the machining result and excesses of tolerance ensue. As wearing, here sometimes the change of shape of the cutting edge and the cutting surface of the tool are understood. Among other things, the extent of wearing depends on the hardness, the abrasion resistance, the heat resistance, the durability of the work-piece and of the cutting piece, but is also determined by the surface condition of the cutting edge, the friction coefficient, and by the lubricity of a used cutting oil.

In order to therefore prevent the manufacture of work-pieces with a too-strongly worn tool, or to avoid a tool breakage, an exchange is, in the conventional art, undertaken, according to an empirically established tool life, in order to keep downtimes of a machine tool, and the production of rejects to a minimum. Here, wear mark width can be checked, which represents the approximately uniform removal of the cutting material through friction on the tool flank(s). Here, the wear mark width is always measured parallel to the cutting edge. Thus, for example a tool is exchanged in the conventional art, if the wear mark width, according to an empirical appraisal, exceeds a threshold value for a wear mark width with a certain probability. At an optimal juncture in time, at which the size of the wear marks and the regrinding quantities for the tool achieve an optimum result simultaneously taking into account the machining quality to be attained. Alternatively, the exchange of cutting elements, such as for example cutting plates or indexable cutting plates, can also be optimized depending upon machining quality and tool costs.

In addition, it is disadvantageous if processes for monitoring wear slowly approach a reasonable replacement time of the tool first through a preceding learning operation, as is the case in many a learning wear monitoring process. The waste incurred in the meantime can represent a considerable economic disadvantage, and even the smallest changes in the machining lead to often non-foreseeable changes in the wear behavior, so that the “learning curve” must once more approach an acceptable value.

It is therefore the object of the present disclosure to create a device or a method which overcomes the abovementioned disadvantage and provides for an exchange of a tool at exactly the right juncture in time, independent of already-passed tool life. This is of advantage for the efficiency of the device, and creates a consistently high quality of the machined work-piece.

The device according to the present disclosure furthermore offers a possibility for documenting the wear behavior on the tool, in order to so document the wearing process over the tool life. Conclusions and determinations can thus be drawn on suitable regrinding time junctures, or also compare different tool materials, coatings, or tool batches with one another.

The described disadvantages of the conventional art are overcome by means of the method and device described herein. Such a device includes a tool receptacle for releasably clamping a tool including clamping a hob peeling wheel, a machining head, which is provided with the tool receptacle, and is designed to drive a tool clamped therein and move it relative to a work-piece to be machined, as well as an assessment unit with a unit for imaging a tool or a part thereof, in order to detect the state of wear of the tool.

Through the imaging of the tool with the aid of the assessment unit, which can include an optical unit, a optical measuring system, and/or a measuring probe, or through the imaging of a part thereof and the detecting of the state of wear, an exchange or a regrinding can be undertaken, independently of a tool life of the tool, and furthermore the regrinding amount can be established. It is now no longer necessary to assume the wear of a tool on the basis of empirical studies, which are dependent upon the tool life of the tool, but rather, depending on the actual wear, an exchange or a regrinding of the tool can occur. This has the advantage that each tool makes use of its maximum tool life with regard to the wear, without having first to build up empirical values. Here, it is not required to take into consideration certain safety zones or values, so that the desired wear point is thus precisely establishable.

It can thus be provided that an enlarged representation of a cutting edge, or multiple cutting edges, of a tool are displayed to a user of the device, whereupon this user can judge the state of wear in a simple manner, and, if necessary, can correspondingly react. It is advantageous here that the user can also appraise the tool wear at a location distant from the device, and does not have to especially go to the device, in order to undertake a visual inspection of the tool. The accessibility of the tool or of the tool blade, e.g. in a hanging installation, is possible with difficulty, or the lighting situation in the work space makes a qualified observation of the tool in different lighting conditions difficult. In the device according to the present disclosure, the assessment unit or a suitable measuring unit can be configured correspondingly small, and can be supported, as required, through a suitable illumination unit, in order to create a reproducible uniform illumination situation.

According to a further development of the situation, the assessment unit is therefore designed to image at least one of multiple cutting edges, potentially in an enlarged representation, so that a good overview over the actual state of wear of the tool can be obtained. Here, the assessment unit can, along with an optical unit, such as e.g. a camera, also include optical or mechanical measuring units, which are employed for the wear documentation.

Here, it is not absolutely required that all cutting teeth or cutting edges of a tool are imaged or approached through the assessment unit, but it is rather sufficient for the purposes of the present disclosure, if a previously determined number of blades or blade edges are imaged, or only every second or third blade or blade edge.

Here, it can also be provided that the present disclosure is provided with a display unit, in order to display the image generated by the optical unit, to output corresponding characteristic values for the wear mark width, or also to document the wearing.

According to the further development of the present disclosure, the device further comprises a storage unit, in order to store the image produced by the tool, as well as potentially further information in connection therewith. Through the storing of the images, these can be retrieved at any time. Therefore, if the same work-pieces are always machined with the same tool within the tool life cycle, then it is possible that these pictures provide information about the tool life behavior between the respective tool reconditionings (for e.g. a regrinding).

Additionally to the documentation of wear, further machining information can also be stored. Through the recording of the previous tool life of the tool, from motor or control parameters of the machine axes involved in the machining, a correlation can be formed between the machining result, the wear, and from parameters of the machine tool, which makes conclusions and determinations about the machining process possible, and which can be used for the purposes of the process optimization. Possible parameters here are potentially the current consumption, or power input, the input voltage, and/or a target/actual comparison of the NC_axis position, partly referred to as lag distance.

According to a further embodiment, the assessment unit, for the documentation of wear, is a optical unit, such as a camera or a microscope camera, a laser scanner, but also a mechanical measuring device, with which the wear mark can be approached. If one uses a laser scanner as an optical unit, the corresponding offsets of the lines of the laser scanner are determined, and therefrom the state of wear of the edge is determined. When using a camera, the state of wear can be recognized based on the edge quality of the imaged cutting edge of the tool. Via a manual focus function, potentially, however, an autofocus function and measuring in different focal planes, the wear mark depth, for example, can be measured. Thus, through determining the optical distance on which, in certain focal planes parts of the tool are sharply drawn, conclusions and determinations can be drawn about the wear mark width/depth. Further, via focal planes and the machine NC axes, the optical unit can be advanced to the tool, and thus likewise a value for the wear size can be determined.

Furthermore, it can be provided, according to the present disclosure, that the assessment unit is arranged on a separate movement device, which makes a relative movement relative to a resting tool possible. If the tool to be examined, as well as also the assessment unit are arranged on the stand of a machine tool, certain movements of the assessment unit relative to the tool cannot be carried out. In such a situation, the assessment unit is provided with a movement device, so that the assessment can be traversed into the corresponding imaging position relative to the tool.

According to the present disclosure, it can be further provided that the present disclosure includes a semi- or fully automatic tool changer, which is designed to receive a tool located in the tool receptacle, and to clamp a different tool in the tool receptacle, wherein the assessment unit is designed to image the tool received by the tool changer, or to image a part thereof, and wherein the assessment unit is potentially arranged on the tool changer.

In machine tools, it is customary to change the tool with the help of a tool changer. In cutting gear machines, potentially in large-scale use, a tool changer can likewise find use. The manual changing operation is thereby omitted, whereby the efficient of such a machine can be increased. Thus, the present disclosure if the assessment unit is potentially arranged in such a changing device, so that the operation for imaging the tool, with which a machining of a work-piece has been undertaken, does not lead to an unnecessary interrupting of a work operation of the machine tool.

It can thus be provided that the tool changer receives the tool after a machining of a work-piece, and is examined through the assessment unit before or after a laying down in a tool magazine. Here, the movement devices already present on the tool changer can be used in order to displace the tool in a region or to hold it in a region, in which the assessment unit can undertake an imaging of the of the tool. If needed, it can also be provided here that the assessment unit is provided with a movement device, which makes a relative movement of the assessment unit relative to the tool received by the tool changer possible.

It can further be provided here, that the tool is clamped in a rotatable mounting during the measuring and documenting of the wear marks through the assessment unit. Thus, in a consistent receiving area of the assessment unit, a neighboring cutting edge can, through rotating of the tool, be rotated in the receiving area of the assessment unit, without a moving of the assessment unit or a re-setting of the imaging settings of the assessment unit required. This ensures a rapid generation of an imaging sequence, which involves multiple portions of the tool.

Potentially, the device according to the present disclosure is a gear cutting machine, such as a hob peeling machine. The gear cutting machine is designed to generate or to define a gearing in a work-piece with a tool such as a hob peeling wheel.

In gear cutting machines, the quality of production of a gearing depends, inter alia, on the faultless state of the quality of the cutting edges of the tool. It is therefore, in such gear cutting machines, of advantage, if the tool is not exchanged before an optimal wear point, and also not after an optimal wear point. In this way, an effective and economical operation of a gear cutting machine be provided.

According to an embodiment of the present disclosure, the assessment unit includes a measuring probe, and/or includes a measuring probe as well as a camera or a laser scanner.

According to a further modification of the present disclosure, the device further includes a computing unit for processing the image and measurement results generated by the assessment unit, as well as for representing and/or highlighting the state of wear of the imaged tool, wherein the calculating unit is, along with the representing of the state of wear, potentially also designed to represent a wear limit of a cutting edge in the image, in order to be able to recognize, in a viewing of the image, the current degree of wear of the tool, in a simple manner.

A simple optical examination of the tool is possible, in which an observer of the image can make the decision, in a simple manner, about the further use of the tool, based on the represented or the highlighted state of wear in the image. Thus, for example, in the image of a cutting edge of the tool, a line can be employed in the image, which line represents an just tolerable level of an abrasion of the cutting edge. If the cutting edge is, by contrast, behind such a line as the state of wear is correspondingly bad, the observer of the image modified thusly recognizes that an exchange or a regrinding of the tool is useful.

The present disclosure further includes a method for recognizing a tool wearing in a device according to one of the abovementioned variants, wherein, in the method, after a machining of a work-piece with a tool, the assessment unit creates an image of the tool wear, such as a cutting edge of the tool, and the image is displayed on via a display unit. It is thereby made possible for an observer, without actual physical presence at the device, to judge the state of wear of the tool. The exchange of a tool is therefore no longer undertaken due to empirical criteria.

It is further possible in the method, that an imaging, generated through the optical unit, is stored in a storage unit, in order to be able to retrieve it at a later juncture in time. If the same work-pieces are always machined with the same tool within the tool life cycle, then these pictures can also provide information about the tool life behavior between the respective tool reconditionings (for e.g. regrinding the tool), coating variants, tool and work-piece batches.

According to a further modification of the method, the optical unit, in the imaging process of the tool, makes recordings from multiple perspectives, such as recordings from multiple viewing directions on an blade of the tool, in order to make a better appraisal of the degrees of wear possible. Therefore, the optical unit can be moved with a movement device, or consist of multiple camera units with different orientations.

In a step cut, this is of advantage, as one here would like to obtain a three-dimensional impression, in order to detect the state of the step cut.

Potentially, the stored images of a tool and the further information standing in connection therewith, such as a juncture in time of recording, the tool life of the tool, and/or motor and control parameters of the machine axes are, with help from statistical methods, evaluated, in order to obtain conclusions and determinations about the machine behavior and the material behavior of the tool employed. The correlations occurring here in the stored information, or in the systematic changes of the motor parameters, in addition allow conclusions and determinations about the material behavior employed.

Further, according to an embodiment of the present disclosure, the state of wear of the said tool can be determined on the basis of the imaging of a tool, potentially with the help of a computing unit, wherein, depending thereon, a regrinding or an exchange of the tool by a tool changer is permitted automatically by the computing unit.

The exchange or the regrinding of the tool is therefore undertaken on the basis of an assessment of the imaging generated through the optical unit. The assessment here occurs by means of a computing unit.

According to a further modification of the present disclosure, the assessment unit is designed to carry out an automatic image processing, such as image recognition, potentially in the framework of a pattern recognition, it is thusly possible to automatically determine the state of wear from a picture. It is therefore no longer necessary, as hitherto set out, that an observer must look at the picture in order to judge the state of wear. For a typical course of a wearing can be searched for an recognized as a sample, as well as the course of the cutting edge. Current camera systems or optical measuring system with suitable software can, based on picture data, e.g. a point cloud, detect the course of the cutting edge. If one carries out this measuring in comparison to the tool edge on the new tool, virtual regions can be defined (one or more parallel regions to the cutting edge (similar to the course of contour lines in maps)), in the exceeding of which, the tool is judged to be worn. Potentially, it is provided that the machine operator can still intervene, in order to enable the tool for a further usage, until a further wear range is exceeded. Alternatively thereto, the tool can also be removed and sent for re-machining.

The removing of the tool can here be carried out fully-automatically, without involvement of a machine operator. The machine can therefore also fully automatically replace the tool if it is worn, and/or document the development of the wear. The course of the wear can also then thus be detected via the profile. The thusly configured assessment unit thus comprises functionalities, which go beyond an image processing to supporting the machine operator, as it can now automatically be decided, through image processing and a corresponding logic, by the assessment unit, if a state of wear is present and tool exchange is to be undertaken. The assessment unit can be supported by a computing unit for the carrying out of image processing, which computing unit carries out the corresponding steps of the image processing.

Further advantages, features and properties of the present disclosure are discernible based on the following figure description.

### BRIEF DESCRIPTION OF THE FIGURES

FIG. 1 shows a perspective view of a gear cutting machine with a tool changer according to the present disclosure.

FIG. 2 shows an enlarged representation of the tool changer with the assessment unit of the present disclosure,

FIG. 3 shows a lateral view of the tool changer with the assessment unit according to the present disclosure.

FIG. 4 shows imaging examples captured through an assessment unit, here an optical unit, which imaging examples show a different state of wear of a cutting edge of a hob peeling wheel.

### DETAILED DESCRIPTION

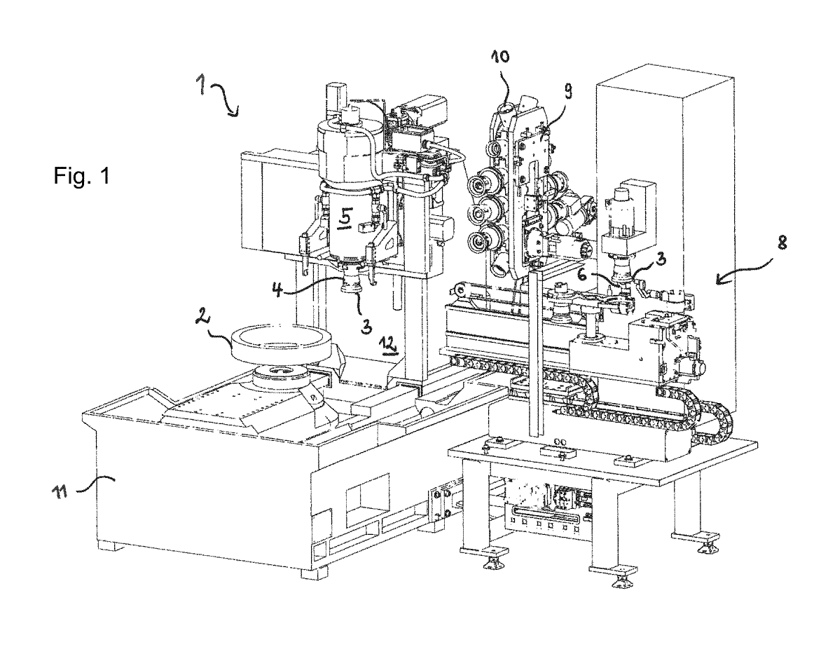

FIG. 1 shows a perspective representation of a gear cutting machine 1, and a tool changer 8 arranged adjacently thereto. The gear cutting machine 1 comprises a machine bed 11, on which the known elements of a gear cutting machine 1 are arranged. From the machine bed 11, the stand 12, which is displaceable in an axial direction relative to the machine bed 11, extends in a vertical direction. On the stand, via a further movement device, the machining head 5 is arranged, which, on its spindle axis, possesses a tool receptacle 4 for clamping a tool 3. By means of the movability of the stand 12, as well as the movability of the machining head, it is possible to move the tool to a desired position relative to the work-piece 2. The work-piece 2 here is drivable around a spindle axis.

As a person skilled in the art knows the mode of action and the capability of a gear cutting machine 1, a detailed description is avoided.

Next to the gear cutting machine 1, a tool changer 8 is arranged, which is in a position to automatically or semi-automatically change the tool 3 from the tool receptacle 4. To that end, the tool 3 is removed from the tool changer, and with the help of the movement device, is supplied to a tool magazine 9. According to the present disclosure, it is now provided that, on the way to the tool magazine 9, the state of wear of the tool 3 is detected by means of the optical unit 6. Upon completion of this procedure, the used tool 3 is then supplied to the tool magazine 9, in that is inserted in a tool holder 10 provided therefor.

Thus, it is possible to estimate and to judge the state of wear of the tools 3 located in the tool magazine 9, if a regrinding or an exchanging of the tool 3 is necessary. It is not necessary to rely upon an empirical tool life, which does not often hit the right juncture in time for changing or for regrinding the tool. Rather, for the evaluation of the state of wear, the actual wearing of the tool 3 is judged, based on the recording of the wear of assessment unit. The evaluation can here also be undertaken by means of a computing unit.

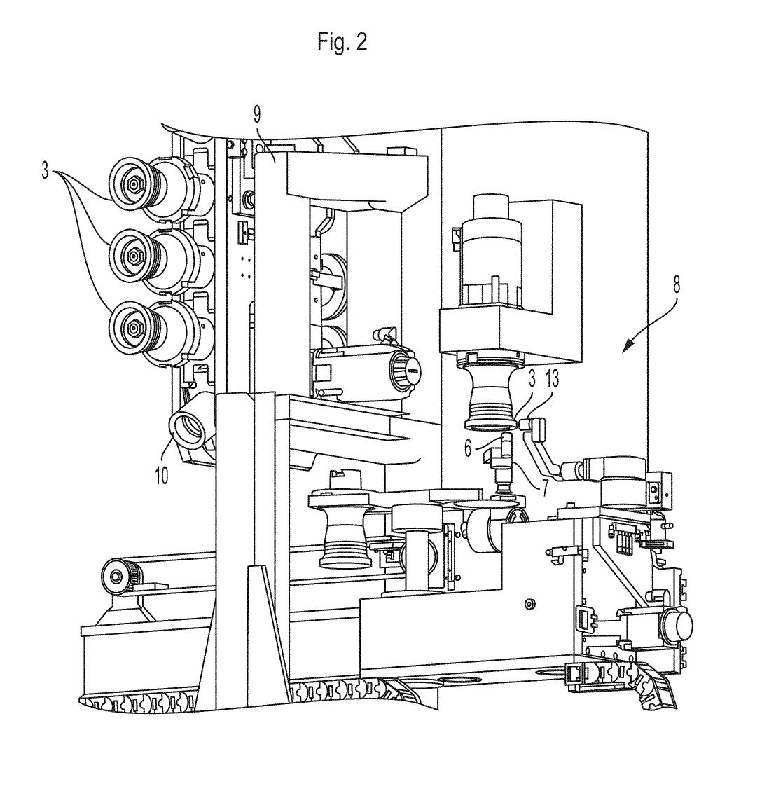

FIG. 2 shows an enlarged section of the tool changer 8, in which one can better recognize the assessment unit, which here is carried out as an optical unit 6. One sees a tool 3 on its way in the direction of the tool magazine 9, which tool is examined by the optical unit 6, which has a movement device 7. Further, one can see a measuring probe 13, which is designed to go over the cutting edge of the tool 3 with a small sphere, and thereby probes, if too great a wearing has already occurred. This operation by the measuring probe 13 can be triggered on the basis of the image captured by the optical unit 6. For example, if the optical unit 6 is configured as an image recording unit, and this recognizes a wearing of the tool 3 in an identified region, the measuring probe 13 is brought in for an exact determination of the wearing of the tool 13. Alternatively, the optical unit can 6 can also be configured as a laser scanner, and thus directly document the amount of the wear.

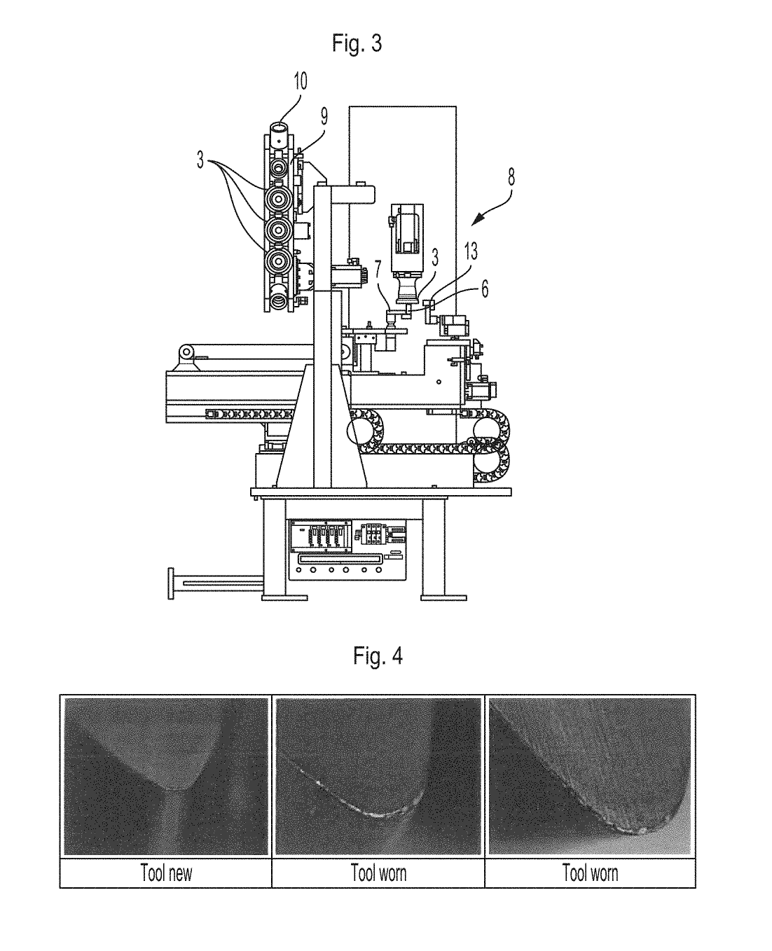

FIG. 3 is a lateral view of the section of the tool changer 8 represented in the FIG. 2. Here, one also recognizes that the optical unit 6, with the help of the movement device 7, can be moved into a corresponding position for image capturing of the tool 3, or a part of the tool 3. Sometimes, for the clean detection of the state of wear of the tool 3, it can also be necessary, to make multiple images, from different positions, of the same tool. Here, the tool to be examined can also be received in a rotatable mounting, in order to be able to rapidly be able to twist the cutting edges into an imaging area.

FIG. 4 shows a cutting edge of a tool in different states of wear. On the left side of the FIG. 4, including in total three illustrations, one recognizes the cutting edge of a tool, which is newly or freshly reground. The middle image shows the cutting edge of a tool, which comprises a wearing. The right of the three images also shows a worn tool. This can be recognized by the rounding of the cutting edges, as well as the wear on the flanks, the tip portion of which cutting edge comprises a fillet.

1. A method for machining a work-piece with a tool, including:
a tool receptacle for releasably clamping a tool,
a machining head, which is provided with the tool receptacle, and drives a tool clamped therein, and moves it relative to a work-piece to be machined, and
at least one assessment unit for imaging or measuring a tool, or a part thereof, in order to detect the state of wear of the tool.

2. The method according to claim 1, wherein the at least one assessment unit images at least one of multiple cutting edges of the tool.

3. The method according to claim 1, further with a display unit, in order to display the image generated by the assessment unit.

4. The method according to claim 1, further with a storage unit, in order to store the image created of the tool.

5. The method according to claim 4, wherein the storage unit further stores a time of the recording, wearing information derived from the image, a tool life of the tool, and/or motor and control parameters of the machining head in a machining of a tool preceding the imaging.

6. The method according to claim 1, wherein the assessment unit is a camera, a microscope camera, or a laser scanner.

7. The method according to claim 1, wherein the assessment unit is arranged on a movement device, which makes a relative movement relative to a resting tool possible.

8. The method according to claim 1, further with a semi- or fully automatic tool changer, which receives a tool located in the tool receptacle, and to clamp a different tool in the tool receptacle, wherein:
the assessment unit images the tool received by the tool changer or a part thereof.

9. The method according to claim 1, wherein the assessment unit is a measuring probe, and/or the assessment unit includes a measuring probe, as well as also a camera or a laser scanner.

10. The method according to claim 1, further including a computing unit for processing the recording of the wear image generated by the assessment unit, and for representing and/or emphasizing the state of wear of the recorded tool.

11. The method according to claim 1, wherein the assessment unit is further carries out an image processing in order to automatically recognize the state of wear of the tool from an image of the tool, wherein, as samples, typical courses of wearing of the tool are stored as images, and the assessment unit searches for matches in the image of the tool.

12. A method for recognizing a tool wearing in a device according to claim 1, wherein, in the method:
after a machining of a work-piece with a tool, the assessment unit creates an image of the tool, and
the image is displayed via a display unit, and wherein
a documentation of the wear and/or image generated by the assessment unit are stored in a storage unit, in order to be able to retrieve them at a later point in time, and
further information in connection with the image are likewise stored in the storage unit.

13. The method according to claim 12, wherein the assessment unit, in the recording process of the tool, makes recordings from multiple perspectives in order to make a better evaluation of the wear of the tool possible.

14. The method according to claim 12, wherein the stored images of a tool and the further information standing in connection therewith, including the time of the recording, wear information derived from the image, the tool life of the tool, and/or motor and control parameters of the machining head, are assessed using statistical methods, in order to determine the machine behavior and the material behavior of the tool employed.

15. The method according to claim 12, wherein, on the basis of the image of a tool, the state of wear thereof is determined, through a computing unit, and depending thereupon a regrinding or an exchanging of the tool is undertaken through a tool changer automatically.

16. A method for machining a work-piece with a tool, including:
a tool receptacle for releasably clamping a hob peeling wheel, and
a machining head, which is provided with the tool receptacle, and drives a tool clamped therein, moves it relative to a work-piece to be machined,
an assessment unit for imaging and measuring a tool, or a part thereof, detecting the state of wear of the tool.

17. The method according to claim 16, further with a storage unit, in order to store the image created of the tool, as well as further information in connection therewith.

18. The method according to claim 4, wherein the further information are the time of the recording, wearing information derived from the image, the tool life of the tool, and/or motor and control parameters of the machining head in a machining of a tool preceding the imaging, wherein the motor and control parameters are a current consumption, or power input, an input voltage, and/or a lag distance.

19. The method according to claim 16, further with a semi- or fully automatic tool changer, which receives a tool located in the tool receptacle, and to clamp a different tool in the tool receptacle, wherein:
the assessment unit images the tool received by the tool changer or a part thereof, and the assessment unit is arranged on the tool changer.

20. The method according to claim 16, further including a computing unit for processing the recording of the wear image generated by the assessment unit, and for representing and/or emphasizing the state of wear of the recorded tool, wherein the computing unit represents a wear limit of a cutting edge in the image, in order to, in an observation of the image, be able to recognize the degree of wear of the tool.
